(19) United States
(12) Patent Application Publication
(10) Pub. No.: US 2015/0260298 A1
(43) Pub. Date: Sep. 17, 2015

(54) MULTIWAY VALVE

(71) Applicant: DIEHL AEROSPACE GMBH, Ueberlingen (DE)

(72) Inventors: Steffen POGGEL, Stuttgart (DE); Sven SCHMIDT, Stuttgart (DE)

(73) Assignee: DIEHL AEROSPACE GMBH, Ueberlingen (DE)

(21) Appl. No.: 14/657,404

(22) Filed: Mar. 13, 2015

(30) Foreign Application Priority Data
Mar. 15, 2014 (DE) 102014003802.5

(51) Int. Cl. F16K 11/02

(52) U.S. Cl. CPC F16K 11/02

(57) ABSTRACT

The invention relates to a multiway valve with a distributor housing (1) having a tubular passage (2), with an inlet opening (3) and multiple outlet openings (5, 6), wherein each outlet opening (5, 6) is assigned a valve obturator (8, 9) accommodated in an axially rotatable manner in the tubular passage (2), wherein the valve obturator (8, 9) has an axial aperture (14) and an outlet duct (13, 15) which branches off radially from the aperture (14) such that by rotating the valve obturator (8, 9) the outlet duct (13, 15) can as desired be set to match up with the corresponding outlet opening (5, 6), and a drive device (18) for rotating the valve obturator (8, 9).

### BACKGROUND OF THE INVENTION

The invention relates to a multiway valve which is in particular suited to supplying gas to a reformer fuel cell system.

### DISCUSSION OF THE PRIOR ART

EP 2413409 A1 discloses a central media supply unit for a reformer fuel cell system. In that context, a tubular passage with an inlet opening and multiple outlet openings is provided in a housing block. A throughflow through an outlet opening can be controlled as desired by means of a proportional valve assigned to the outlet opening.

The known media supply unit, in particular the housing block, involves high production costs. Furthermore, it is not of particularly compact configuration.

### SUMMARY OF THE INVENTION

The invention has the object of overcoming the drawbacks of the prior art. It should in particular propose a multiway valve which is as simple and as cost-effective as possible to produce, and which is of compact construction.

The invention proposes a multiway valve with a distributor housing having a tubular passage, with an inlet opening and multiple outlet openings, wherein each outlet opening is assigned a valve obturator accommodated in an axially rotatable manner in the tubular passage, wherein the valve obturator has an axial aperture and an outlet duct which branches off radially from the aperture such that by rotating the valve obturator the outlet duct can as desired be set to match up with the corresponding outlet opening, and a drive device for rotating the valve obturator.

The proposed multiway valve consists of few parts, is of simple construction and is compact. The distributor housing can at least be made from a tube with a section accommodating the valve obturator. By varying the length of the tube and the number of valve obturators accommodated therein, the multiway valve can simply be adapted to respective application requirements.

According to one advantageous configuration of the invention, the valve obturator is designed as a tube section. In this case, it becomes unnecessary to create the axial aperture. All that remains is to create a bore in the tube wall of the outlet duct. This further simplifies the production of the multiway valve. Expediently, the valve obturator is sealed with respect to the passage by means of a first seal. The first seal can be two annular seals provided on the outer perimeter of the valve obturator.

Multiple valve obturators arranged adjacent to one another are advantageously of identical construction. Advantageously, the apertures of adjacent valve obturators form a distributor duct which is connected to the inlet opening. Expediently, adjacent valve obturators bear against each other, with an axial bearing interposed between them. It is thus possible to achieve a particularly compact construction of the multiway valve.

According to a further configuration, a further outlet opening, oriented towards the distributor housing, of the outlet duct is surrounded by an annular seal. The annular seal can be affixed to the distributor housing or to the valve obturator.

In a particularly compact configuration, adjacent outlet openings are arranged offset with respect to one another with reference to a circumferential direction of the passage. This makes it easier to affix an outlet connector to the exit of the outlet opening. To that end, the outlet opening can for example be provided with an internal thread such that, by creating a screw connection, an outlet connector can be connected to the distributor housing.

For the purpose of position adjustment, the valve obturator can have, extending therefrom, a control rod which passes through a corresponding slot extending in the circumferential direction in the distributor housing. A second seal, surrounding the slot, can be provided between the passage and the valve obturator.

The drive device can comprise a servomotor drive-connected to the control rod. According to one alternative, the control rod can also be omitted. In this case, the drive device is advantageously an electromagnetic actuator by means of which the valve obturator, which has magnetic portions, can be rotated in contactless fashion. Advantageously, the valve obturator and the drive device together form a proportional valve.

A mass flow sensor can be provided downstream of the outlet opening. The drive device and the mass flow sensor can be connected to an open- or closed-loop control. It is thus possible to control exactly, in open- or closed-loop fashion, with each of the valves of the multiway valve, a mass flow of a fluid guided through the latter.

According to a further configuration, a blower, preferably a turbo blower, is provided upstream of the inlet opening for supplying air to the distributor housing. In this case, an air supply unit formed from the multiway valve and the blower is particularly suited to supplying air to reformer fuel cell systems.

### BRIEF DESCRIPTION OF THE DRAWINGS

An exemplary embodiment of the invention will be explained in more detail below with reference to the drawing in which:

FIG. 1 shows a multiway valve in accordance with the present invention.

### DETAILED DESCRIPTION OF THE INVENTION

In the single figure, a distributor housing is labelled with the reference sign 1 and has a tubular passage 2. The distributor housing 1 can—as represented in the figure—be made for example from a tube. The distributor housing 1 has an inlet opening 3, upstream of which an inlet connector 4 can be arranged.

The distributor housing 1 has multiple first outlet openings 5 and multiple second outlet openings 6, downstream of which first outlet connectors 7a and second outlet connectors 7b are respectively arranged. A first diameter of the first outlet openings 5 is smaller than a second diameter of the second outlet openings 6.

The first outlet openings 5 are assigned first valve obturators 8. The second outlet openings 6 are assigned second valve obturators 9. The valve obturators 8, 9 are respectively designed as a tube section accommodated in an axially rotatable manner in the tubular passage 2. Advantageously, an axial bearing 10 is in each case provided between adjacent valve obturators 8, 9. Extending from each valve obturator 8, 9 is a control rod 11 which in each case passes through a corresponding slot 12 in the distributor housing 1.

The first valve obturators 8 have first outlet ducts 13 which extend radially from an aperture 14 in each of the first valve obturators 8. Similarly, the second valve obturators 9 have second outlet ducts 15 which extend radially from the aperture 14 extending through the second valve obturators 9. A further first diameter of the first outlet ducts 13 is smaller than a further second diameter of the second outlet ducts 15. A third diameter of the aperture 14 is expediently identical in all valve obturators 8, 9. The adjoining apertures 14 form a distributor duct 16 which is in connection with the inlet opening 3.

Reference sign 17 designates seals which seal off the valve obturators 8, 9 with respect to the passage 2. Reference sign 18 designates a schematically represented drive device for adjusting the position of the control rods 11.

Operation of the multiway valve is as follows:

Compressed air is urged, for example by means of a turbo blower, through the inlet opening 3 into the tubular passage 2 of the distributor housing 1. The air is distributed through the distributor duct 16 formed by the mutually adjoining apertures 14 of the valve obturators 8, 9. By rotating the valve obturators 8, 9 by means of the control rod 11 and the drive device 18, the first 13 and/or the second outlet duct 15 can, as desired, be made to match up with the first 5 and/or the second outlet opening 6, such that a flow of air out from the respective outlet opening 5, 6 can thus be controlled in open- or closed-loop fashion.

The valve obturators 8, 9 can be moved independently of one another by means of the respective drive devices 18. In order to generate suitable positioning movements, mass flow sensors (not shown here) can be arranged downstream of the outlet openings 5, 6. On the basis of the signals provided by the mass flow sensors, an open- or closed-loop control can suitably set the respective valve obturator 8, 9 such that a predetermined mass flow of air is released from the respective outlet opening 5, 6.

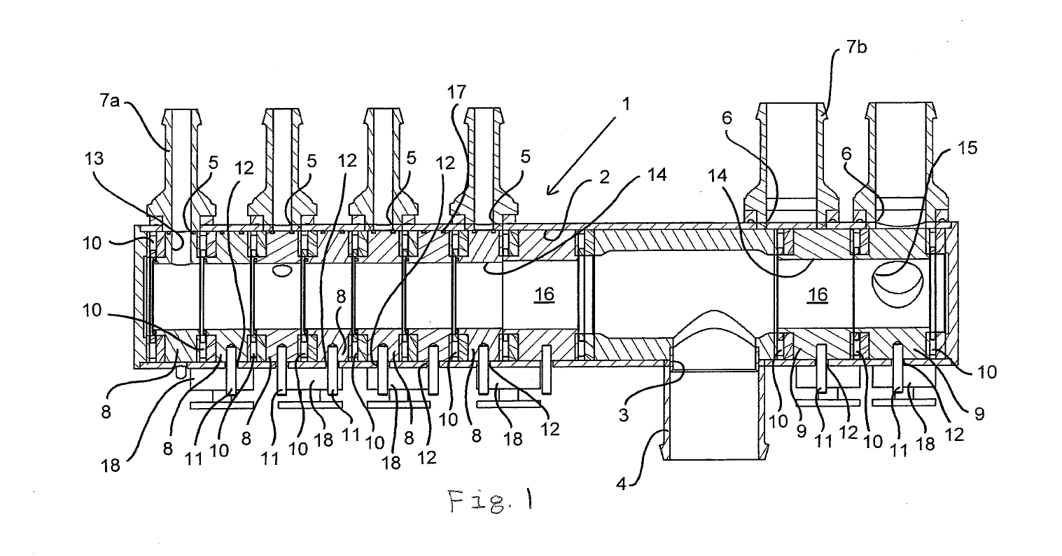

Although not shown in FIG. 1, it can also be the case that the distributor housing 1 is of multipart construction. In particular, a section of the distributor housing 1, having only the inlet opening 3, can be embodied as a separate component. In this case, the tube sections which are shown in the single figure and which extend to the left and to the right of the inlet opening 3 can also be embodied as separate components. A modular construction of the multiway valve, configured thus, further simplifies production of the latter. The multiway valve can easily be adapted to predetermined requirements.

Instead of the drive, shown in FIG. 1, by means of a control rod 11 and a drive device 18, it is also possible to provide a contactless drive for adjusting the position of the valve obturators 8, 9.

### List of Reference Signs

1 Distributor housing
2 Passage
3 Inlet opening
4 Inlet connector
5 First outlet opening
6 Second outlet opening
7a First outlet connector
7b Second outlet connector
8 First valve obturator
9 Second valve obturator
10 Axial bearing
11 Control rod
12 Slot
13 First outlet duct
14 Aperture
15 Second outlet duct
16 Distributor duct
17 Seal
18 Drive device

What is claimed is:

1. A multiway valve with a distributor housing having a tubular passage, with an inlet opening and multiple outlet openings, wherein each outlet opening is assigned a valve obturator accommodated in an axially rotatable manner in the tubular passage, wherein the valve obturator has an axial aperture and an outlet duct which branches off radially from the aperture such that by rotating the valve obturator the outlet duct can as desired be set to match up with the corresponding outlet opening, and a drive device for rotating the valve obturator.

2. The multiway valve according to claim 1, wherein the valve obturator is designed as a tube section.

3. The multiway valve according to claim 1, wherein the valve obturator is sealed with respect to the aperture by means of at least one first seal.

4. The multiway valve according to claim 1, wherein the apertures of adjacent valve obturators form a distributor duct which is connected to the inlet opening.

5. The multiway valve according to claim 1, wherein adjacent valve obturators bear against each other, with an axial bearing interposed between them.

6. The multiway valve according to claim 1, wherein a further outlet opening, oriented towards the distributor housing, of the outlet duct is surrounded by an annular seal.

7. The multiway valve according to claim 1, wherein adjacent outlet openings are arranged offset with respect to one another with reference to a circumferential direction of the passage.

8. The multiway valve according to claim 1, wherein the valve obturator has, extending therefrom, a control rod which passes through a corresponding slot extending in the circumferential direction in the distributor housing.

9. The multiway valve according to claim 8, wherein a second seal, surrounding the slot, is provided between the passage and the valve obturator.

10. The multiway valve according to claim 8, wherein the drive device comprises a servomotor drive-connected to the control rod.

11. The multiway valve according to claim 1, wherein the drive device is an electromagnetic actuator by means of which the valve obturator, which has magnetic portions, can be rotated in contactless fashion.

12. The multiway valve according to claim 1, wherein a mass flow sensor is provided downstream of the outlet opening.

13. The multiway valve according to claim 12, wherein the drive device and the mass flow sensor are connected to an open- or closed-loop control.

14. The multiway valve according to claim 1, wherein a blower, is provided upstream of the inlet opening for supplying air to the distributor housing.

15. The multiway valve according to claim 14, wherein said blower is a turbo blower.
